(19) United States
(12) Patent Application Publication
(10) Pub. No.: US 2009/0122022 A1
(43) Pub. Date: May 14, 2009

(54) METHOD FOR DISPLAYING CONTENT AND ELECTRONIC APPARATUS USING THE SAME

(75) Inventors: YONG-GOOK PARK, Yongin-si (KR); Ji-hyeon Kweon, Yongin-si (KR); Hyun-jin Kim, Seoul (KR); Myung-hyun Yoo, Seongnam-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/052,079

(22) Filed: Mar. 20, 2008

(30) Foreign Application Priority Data
Nov. 8, 2007 (KR) 2007-113880

(51) Int. Cl. G06F 3/041

(52) U.S. Cl. 345/173

(57) ABSTRACT

A method of displaying content and an electronic apparatus using the same, the method of displaying content of an electronic apparatus using an touchscreen including: dividing the touchscreen into a viewable area and an un-viewable area according to a touching of the touchscreen; and displaying the content on the viewable area. Accordingly, a user more conveniantly manipulates an electronic apparatus.

### CROSS-REFERENCE TO RELATED APPLICATION

This application claims the benefit of Korean t Application No. 2007-113880, filed Nov. 8, 2007 in the Korean Intellectual Property Office, the disclosure of which is incorporated herein by reference.

### BACKGROUND OF THE INVENTION

1. Field of the Invention

Aspects of the present invention relate to an electronic apparatus and a control method thereof, and more particularly, to a method of displaying content and an electronic apparatus using the same.

2. Description of the Related Art

Generally, an electronic apparatus (such as an MPEG layer 3 (MP3) player) retrieves video and/or audio data from a storage having a small size (such as a flash memory or a hard disc drive (HDD)), and decodes the retrieved video and/or audio data in order to play back the video and/or audio data. Furthermore, the electronic apparatus operates according to user commands displaying an operation state to a user through a display panel (such as a liquid crystal display (LCD)).

Though the electronic apparatus should provide a user with convenience and portability, a size of the electronic apparatus increases as more keys are added thereto. As a result, it is inconvenient for a user to carry the electronic apparatus, and an appearance of the electronic apparatus is degraded. Accordingly, a display panel having a touchscreen has increasingly been used as an input device to receive user commands.

Specifically, if a user contacts the touchscreen with a finger to input a command, the finger covers a part or an entirety of the touchscreen. After the user touches the touchscreen to input the command, the user should remove his or her finger from the touchscreen in order to determine if the command is input properly. As a result, the user experiences increased inconvenience when playing back a file because the user should repeatedly touch the touchscreen.

### SUMMARY OF THE INVENTION

Aspects of the present invention relate to a method of conveniently displaying content in which a moving line of a finger is shortened when a user inputs a command by touching a screen with his or her finger, and an electronic apparatus using the same.

According to an aspect of the present invention, there is provided a method of displaying content of an electronic apparatus using a touchscreen, the method including: dividing the touchscreen into a viewable area and an un-viewable area according to a touching of the touchscreen; and displaying the content on the viewable area.

The method may further include displaying a selectable item on an area of the touchscreen, wherein the dividing divides the touchscreen into the viewable area and the un-viewable area when the area of the touchscreen is touched.

The displaying may display a sub menu of the selected item on the viewable area.

The displaying may arrange respective items of the sub menu adjacent to the selected item.

The displaying may display items of the sub menu in a row such that the items may be touched in a dragging path from the selectable item.

The displaying may display a dynamic item on an edge of the touchscreen.

The touching may cover the edge of the touchscreen when selecting the dynamic item, such that a viewable area of the touchscreen is maximized.

The touching may be performed by a finger of a user.

The dividing may further include recognizing a spacing of the touching from the touchscreen by a predetermined distance using a three dimensional (3D) touch sensor.

According to another aspect of the present invention, there is provided an electronic apparatus to display content, the electronic apparatus including: a touchscreen to receive a user command through a touching thereon, and to display the content corresponding to the user command; and a control unit to divide the touchscreen into a viewable area and an un-viewable area according to the touching of the touchscreen, and to control the touchscreen to display the content corresponding to the user command on the viewable area.

The control unit may divide the touchscreen into the viewable area and the un-viewable area when a selectable item displayed on an area of the touchscreen is touched.

The control unit may control the touchscreen to display a sub menu of the selectable item on the viewable area.

The control unit may control the touchscreen to arrange respective items of the sub menu adjacent to the selected item.

The control unit may control the touchscreen to display items of the sub menus in a row such that the items may be touched in a dragging path from the selectable item.

The control unit may control the touchscreen to display a dynamic item on an edge of the touchscreen.

The touching may cover the edge of the touchscreen when selecting the dynamic item, such that a viewable area of the touchscreen is maximized.

The touching may be performed by a finger of a user.

The apparatus may further include a three dimensional (3D) touch sensor to recognize a spacing of the touching from the touchscreen, and to transmit the spacing to the control unit.

According to yet another aspect of the present invention, there is provided an electronic apparatus to display content, the electronic apparatus including: a touchscreen to receive a user command through a touching thereon, and to display the content corresponding to the user command; and a control unit to divide the touchscreen into a plurality of areas according to the touching of the touchscreen, and to control the touchscreen to display the content corresponding to the user command according to the dividing of the touchscreen.

According to still another aspect of the present invention, there is provided a method of displaying content of an electronic apparatus using a touchscreen, the method including: dividing the touchscreen into a plurality of areas according to a touching of the touchscreen; and displaying the content according to the dividing of the touchscreen.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram illustrating an electronic apparatus according to an embodiment of the present invention;

FIG. 2 is a flowchart explaining a method of displaying content based on display areas of a touchscreen according to an embodiment of the present invention;

FIGS. 3A and 3B are views illustrating viewable and un-viewable areas on a touchscreen according to touch of a finger according to an embodiment of the present invention;

FIGS. 4A to 4D are views illustrating user interface (UI) elements or detail information on a touchscreen according to an embodiment of the present invention;

FIGS. 5A to 5C are views explaining a method of displaying UI elements differently arranged based on a viewable area according to an embodiment of the present invention;

FIGS. 6A to 6C are views explaining a method of displaying dynamic UI elements according to an embodiment of the present invention; and

FIG. 7 is a flowchart explaining a method of displaying menus based on display areas according to another embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

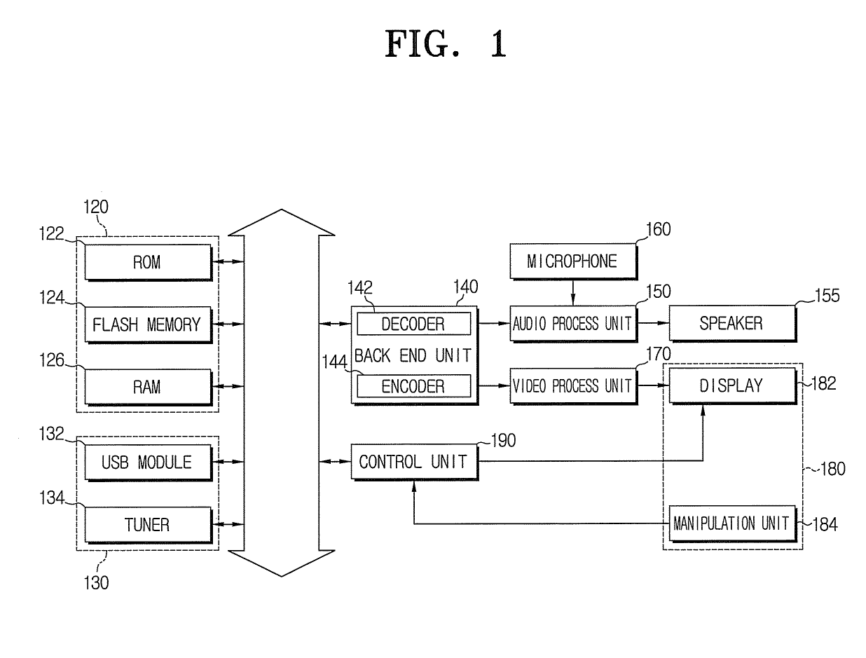

FIG. 1 is a block diagram illustrating an electronic according to an embodiment of the present invention. Though the electronic apparatus illustrated in FIG. 1 is an MPEG layer 3 (MP3) player, it is understood that the MP3 player is only an example, and aspects of the present invention are not limited thereto. Referring to FIG. 1, the MP3 player includes a storage unit 120, a communication interface unit 130, a back end unit 140, an audio process unit 150, a speaker 155, a microphone 160, a video process unit 170, a display 182, a manipulation unit 184, and a control unit 190.

The storage unit 120 stores information used to control the electronic apparatus. For example, in the case of the MP3 player, the storage unit 120 stores program information, content, content information, and icon information used to control the MP3 player. Furthermore, the storage unit 120 includes a read only memory (ROM) 122, a flash memory 124, and a random access memory (RAM) 126. It is understood that other types of memories may be used in addition to, or instead of, the ROM 122, the flash memory 124, and the RAM 126.

The ROM 122 permanently retains information even when the power is switched off. The information may include content of the MP3 player, content information, menu information, icon information, program information related to the icon, and information regarding a command that a user defines. For example, the user may set a user motion as a user command (which will be explained in detail below). The flash memory 124 stores various updateable data and programs to control the back end unit 140. The RAM 126 backs up various temporary data, and operates as a working memory of the control unit 190. The ROM 122 and flash memory 124 retain data when the power is switched off, but the RAM 126 loses data when the power is switched off.

The communication interface unit 130 allows data communication between an external apparatus and the MP3 player, and includes a universal serial bus (USB) module 132 and a tuner 134. However, it is understood that aspects of the present invention are not limited thereto, and may include other types of communication modules (such as a Bluetooth module and/or an infrared module). The USB module 132 transmits and receives data that is input to or output from a USB device (such as a personal computer (PC) or a USB memory). The tuner 134 receives radio and/or television (TV) broadcasts, and transmits the received broadcasts to the back end unit 140. Thus, the content according to aspects of the present invention may include broadcasts in addition to still image files, moving image files, audio files, and text files.

The back end unit 140 processes a video and/or audio signal and includes a decoder 142 and an encoder 144. The processing may include compression, decompression, and/or reproduction. However, it is understood that the back end unit 140 may receive the video and/or audio data in a predetermined format, or a non-encoded format, whereby the back end unit 140 may not include the decoder 142 and the encoder 144 according to other aspects.

The decoder 142 decompresses a file output from the storage unit 120 or data output from the communication interface unit 130, and transmits the decompressed audio data and/or video data to the audio process unit 150 and the video process unit 170, respectively. The encoder 170 compresses the video data and/or audio data output from the communication interface unit 130 into a predetermined format, and transmits the compressed file to the storage unit 120. Furthermore, the encoder 170 may compress an audio output from the audio process unit 150 into a predetermined format, and transmits the compressed file to the storage unit 120.

The audio process unit 150 digitizes an analog audio signal that is input through an audio input element (such as the microphone 160), and transfers the digitized signal to the back end unit 140. Furthermore, the audio process unit 150 may convert a digital audio signal output from the back end unit 140 into an analog audio signal, and output the converted signal to the speaker 155.

The video process unit 170 processes a video signal output from the back end unit 140, and outputs the processed video signal to the display 182.

A touchscreen 180 is a display element having both functions of the display 182 (which displays a video, text, and/or icon output from the video process unit 170 or control unit 190) and the manipulation unit 184 that receives a user command, and transmits the command to the control unit 190. A user can input a user command by touching an area of the touchscreen 180 on which menus are displayed while viewing the menus on the touchscreen 180.

The manipulation unit 184 may include a three dimensional (3D) touch sensor (not shown) using an electrostatic capacitance manner. The 3D touch sensor forms a low energy field on a part of the touchscreen 180, recognizes an energy change when a conductor (such as a finger) is located within the energy field, and transmits to the control unit 190 coordinate data of an area touched by the conductor and/or coordinate data of an area untouched by the conductor.

For convenience of the present description, the touchscreen 180 is divided into a touched area, an un-viewable area, and a viewable area. The touched area represents a part of the touchscreen 180 that a user touches, the un-viewable area represents a part of the touchscreen 180 hidden by a finger of a user, and the viewable area represents a part of the touchscreen 180 that a user can view. The touched area is included in the un-viewable area since the touched area is hidden when a user touches the touchscreen 180. Therefore, the viewable area and the un-viewable area vary as a user moves his hand closer to the touchscreen 180, and touches a part of the touchscreen 180 with his fingertip.

The control unit 190 controls overall operations of the MP3 player. More specifically, if a user inputs a command through the manipulation unit 184, the control unit 190 controls various function blocks of the MP3 player to correspond to the input command. For example, if a user inputs a command to play back a file that is stored in the storage unit 120, the control unit 190 retrieves the file from the storage unit 120 and transmits the retrieved file to the back end unit 140. The back end unit 140 decodes the file, the audio process unit 150 and the video process unit 170 process audio and/or video signals, respectively, of the decoded file, and the control unit 190 controls the function blocks to output the audio and/or video data through the speaker 155 and the display 182, respectively.

If a user inputs a command by touching the touchscreen 180, the control unit 190 divides the touchscreen 180 into a viewable area and an un-viewable area based on the coordinate data transmitted from the manipulation unit 184. The control unit 190 retrieves content (such as menus) corresponding to the input command from the storage unit 120, and displays the retrieved content on the viewable area.

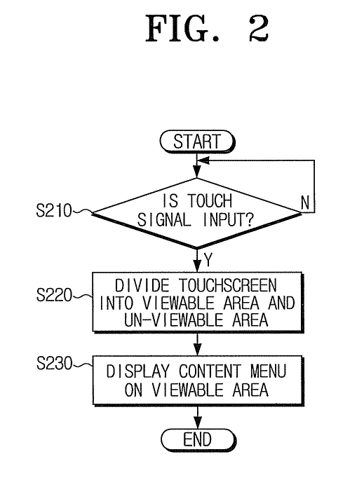

FIG. 2 is a flowchart explaining a method of displaying content based on display areas of a touchscreen 180 according to an embodiment of the present invention. Referring to FIGS. 1 and 2, the control unit 190 determines whether a touch signal is input in operation S210. More specifically, a user touches an area displaying a desired user interface (UI) element with his or her finger to select the desired UI element while viewing the touchscreen 180 displaying menus including user UI elements. A touch sensor (such as a 3D touch sensor) of the manipulation unit 184 transmits coordinate data and a touch signal corresponding to the touched area to the control unit 190. Accordingly, the control unit 190 receives the touch signal and the coordinate data, and determines that the touch signal is input.

If it is determined that the touch signal is input (operation S210-Y), the control unit 190 divides the touchscreen 180 into a viewable area and an un-viewable area in operation S220. Specifically, if a user touches the touchscreen 180, the 3D touch sensor transmits coordinate data and a touch signal of the touched area to the control unit 190, as well as coordinate data and an energy change of an untouched area. The energy change results from an approach of a finger. The control unit 190 divides the touchscreen 180 into a viewable area and an un-viewable area according to the data transmitted from the 3D touch sensor.

The control unit 190 retrieves content corresponding to the selected UI element (for example, one or more sub menus from the storage unit 120), and displays the retrieved content on the viewable area in operation S230.

As described above, as a sub menu corresponding to a UI element is displayed on a viewable area of a touchscreen 180, it is unnecessary for a user to lift his or her finger after touching the UI element in order to view the sub menu corresponding to the UI element, and to select a UI element of the sub menu.

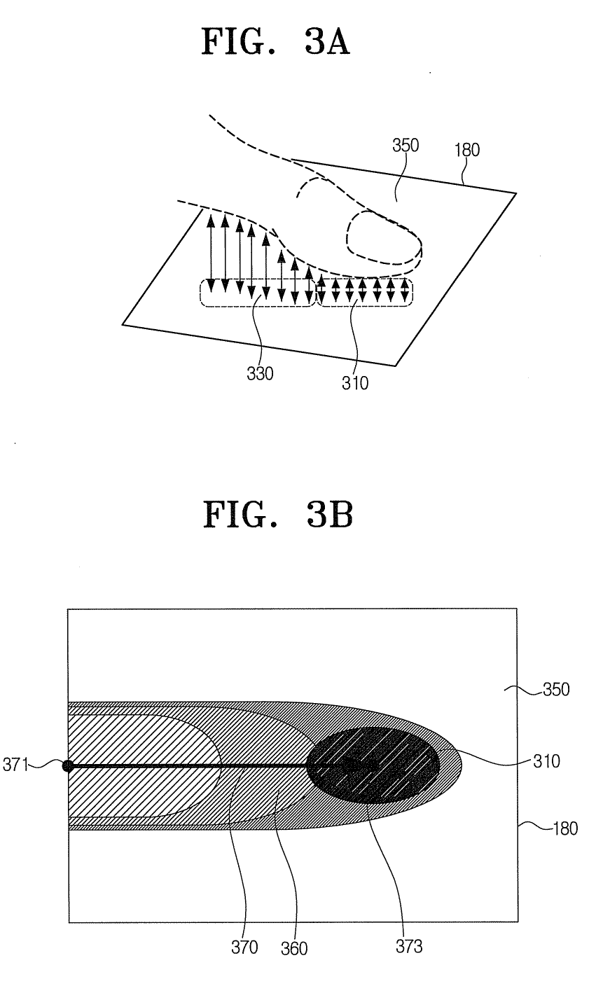

FIGS. 3A and 3B are views illustrating viewable and un-viewable areas on a touchscreen 180 according to a touch of a finger according to an embodiment of the present invention. FIG. 3A is a view illustrating a state in which a user touches the touchscreen 180 with his or her finger according to an embodiment of the present invention. If a user touches an area of the touchscreen 180 with his or her finger, the touchscreen 180 is divided into a first un-viewable area 310 on which the finger touches and covers, a second un-viewable area 330 on which the finger covers but does not touch, and a viewable area 350 on which the finger does not touch or cover.

FIG. 3B is a view illustrating a degree of energy change of an un-viewable area and a viewable area. The first un-viewable area 310 has the highest degree of energy change, since the loss of energy charge in the first un-viewable area 310 is caused by the touch of a finger. The loss of energy charge of the second un-viewable area 330, however, is insignificant. As the finger approaches the touchscreen 180, the electrostatic capacitance of the second un-viewable area 330 changes. The degree of energy change of second un-viewable area 330 is higher than that of the viewable area 350, and is lower than that of the first un-viewable area 310. The control unit 190 computes the degree of energy change based on energy values transmitted from the 3D touch sensor, and divides the touchscreen 180 into the first un-viewable area 310, the second un-viewable area 330, and the viewable area 350 according to the computation.

The energy of the viewable area 350 changes due to the approach of a finger. Accordingly, the control unit 190 may divide the touchscreen 180 into the first un-viewable area 310, the second un-viewable area 330, and the viewable area 350 with reference to a first reference degree of energy change and a second reference degree of energy change, which are both stored in the storage unit 120. Specifically, the degree of energy change of the first un-viewable area 310 is greater than or equal to the second reference degree of energy change, the degree of energy change of the second un-viewable area 330 is less than or equal to the second reference degree of energy change and greater than or equal to the first reference degree of energy change, and the degree of energy change of the viewable area 350 is less than the first reference degree of energy change. A designer of the electronic apparatus or a user of the electronic apparatus may preset the first and second reference degrees of energy change.

A vector for touch 370 (for example, a finger as employed in the illustrated embodiment of the present invention) is provided, in which an edge of the second un-viewable area 330 on the touchscreen 180 indicates a start point 371, and a center 373 of the first un-viewable area 330 indicates an end point as illustrated in FIG. 3B. The control unit 190 may acquire the vector for touch 370 based on a signal transmitted from the 3D touch sensor. The control unit 190 may display content (such as menus) on the viewable area 350 according to the vector for touch 370.

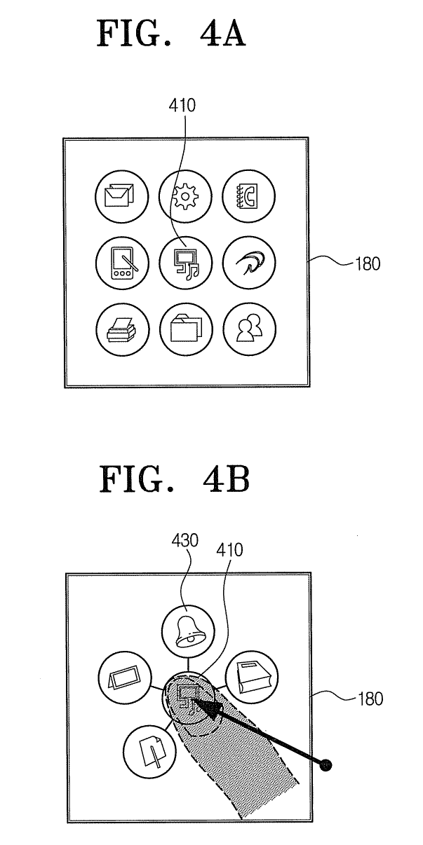

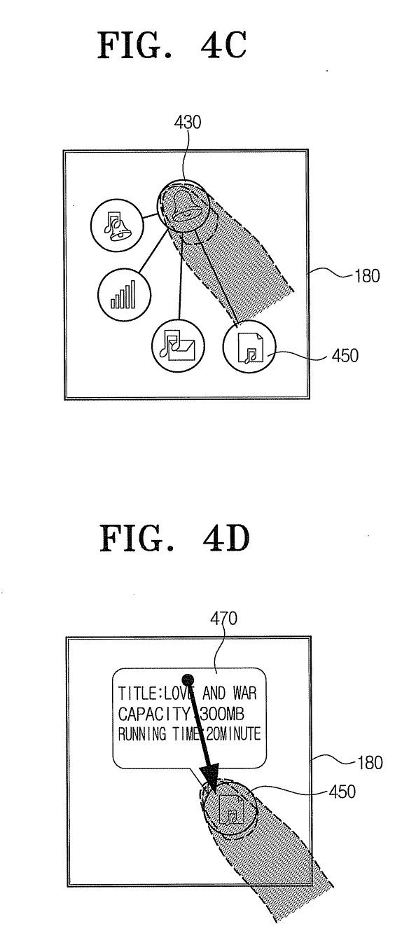

A method of displaying menus or detailed information on a viewable area will now be explained with reference to FIGS. 4A to 4D. FIGS. 4A to 4D are views illustrating UI elements or detail information on a touchscreen 180 according to an embodiment of the present invention.

Referring to FIG. 4A, the touchscreen 180 displays a menu including a plurality of UI elements. A user touches an area displaying a first UI element 410 to select the first UI element 410 from among the plurality of UI elements. The control unit 190 retrieves a first sub menu corresponding to the first UI element 410 from the storage unit 120, and displays the first sub menu on the display 182. When the first sub menu is displayed, the control unit 190 divides the touchscreen 180 into an un-viewable area that a finger covers and a viewable area that the finger does not cover based on the degree of energy change. The first sub menu is displayed on the viewable area as illustrated in FIG. 4B.

Referring to FIG. 4B, it is unnecessary for a user to move his or her finger to view the first sub menu because the first sub menu is displayed on the viewable area. When the first sub menu includes a plurality of sub UI elements, the control unit 190 may control the display 182 so that each of the sub UI elements is arranged adjacent to the first UI element 410. Accordingly, a moving line of the finger is significantly shortened. When the sub UI elements are arranged adjacent to the first UI element 410, a UI element is not displayed between the sub UI elements and the first UI element 410. A user can thus drag his or her finger from the first UI element 410 to a first sub UI element 430, and tap an area displaying the first sub UI element 430 to select the first sub UI element 430 from among the sub UI elements. It is understood that aspects of the present invention are not limited to a dragging of the finger. For example, according to other aspects, a user may simply remove his or her finger from the first UI element 410 and place his or her finger on the first sub UI element 430 without dragging.

FIG. 4C illustrates a case whereby the first sub UI element 430 is selected. If a user inputs a command to select the first sub UI element 430 by touching an area of the touchscreen 180 displaying the first sub UI element 430, the control unit 190 displays a second sub menu corresponding to the first sub UI element 430 on a viewable area of the touchscreen 180. As a finger of the user covers an upper end of the touchscreen 180, the second sub menu corresponding to the first sub UI element 430 is displayed on a viewable area of the touchscreen 180 not including the first sub UI element 430. If the second sub menu includes a plurality of UI elements, the control unit 190 may display the respective UI elements adjacent to the first sub UI element 430.

If a user drags his or her finger from the first sub UI element 430 to a second sub UI element 450, and taps the second sub UI element 450, the control unit 190 displays content 470 (such as detail information) corresponding to the second sub UI element 450 on a viewable area as illustrated in FIG. 4D. It is understood that aspects of the present invention are not limited to a dragging of the finger. For example, according to other aspects, a user may simply remove his or her finger from the first sub UI element 430 and place his or her finger on the second sub UI element 450 without dragging. Furthermore, it is understood that the sub menu and content hierarchy are not limited to the example described above. That is, content may correspond to a UI element on a main menu displayed on the touchscreen 180 without having to first display a sub menu.

In a case that a sub menu includes a plurality of sub UI elements, the respective sub UI elements are displayed adjacent to the selected UI element, so that a user selects a desired sub UI element from the sub menu with minimum movement. If a user takes his or her finger off of the touched area, the touchscreen 180 concurrently displays a UI element and sub menus of the UI element as described in FIGS. 4B and 4C. Accordingly, a user can recognize a correspondence between a UI element and sub menus without having to carry out an additional operation.

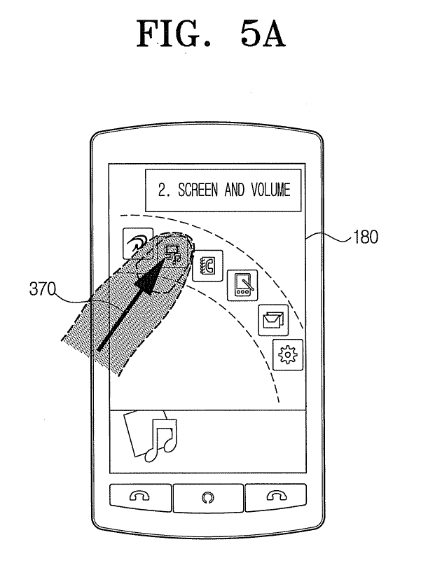

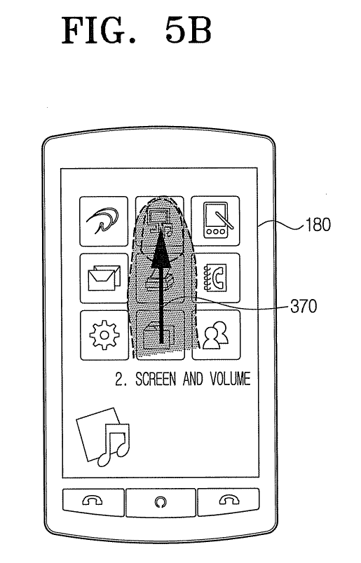

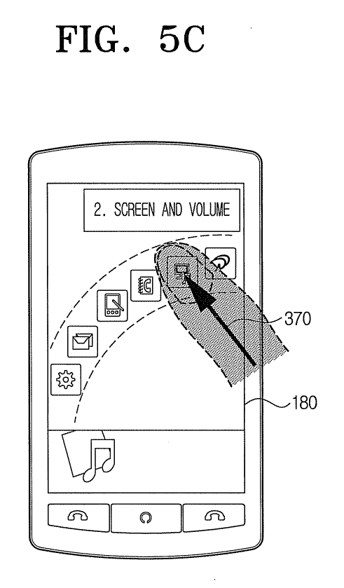

FIGS. 5A to 5C are views explaining a method of displaying UI elements differently arranged based on a viewable area according to an embodiment of the present invention. The UI elements of FIGS. 5A to 5C correspond to the sub UI elements of the sub menu of FIGS. 4A to 4D. If a user selects a desired UI element, the touchscreen 180 displays only the sub menu corresponding to the selected UI element. Various methods for displaying sub menus will be explained below.

FIG. 5A is a view explaining a method of displaying a UI element when a user holds an electronic apparatus in his or her left hand, and manipulates the electronic apparatus with his or her left thumb. When the user holds the electronic apparatus in his or her left hand, the control unit 190 detects an un-viewable area located on a left portion of the touchscreen 180. More specifically, the control unit 190 detects that the vector for touch 370 is directed from a left portion toward a right-upper end of the touchscreen 180. Therefore, the control unit 190 displays respective UI elements in a row arrangement corresponding to a segment of an oval, from the left-upper end of the touchscreen 180 to the right-lower end of the touchscreen 180. The user selects a desired UI element by moving his or her left thumb following the oval pattern. Thus, the user can thus easily input a command using only his left hand.

FIG. 5B is a view explaining a method of displaying a UI element when a user holds an electronic apparatus in his or her left hand, and manipulates the electronic apparatus with a finger on his or her right hand. When the user holds the electronic apparatus in his or her left hand, and selects a desired UI element using a finger on his or her right hand, the control unit 190 detects that the vector for touch 370 is directed from a lower end toward an upper end of the touchscreen 180. Accordingly, the control unit 190 displays UI elements on a viewable area in a matrix form.

FIG. 5C is a view explaining a method of displaying a UI element when a user holds an electronic apparatus in his or her right hand, and manipulates the electronic apparatus with his or her right hand thumb. When the user holds the electronic apparatus in his or her right hand, the control unit 190 displays UI elements in a row from a right-upper end toward a left-lower end of the touchscreen 180. Accordingly, it is convenient for a user to select a desired UI element while moving his or her thumb in an oval pattern from a right-upper end toward a left-lower end.

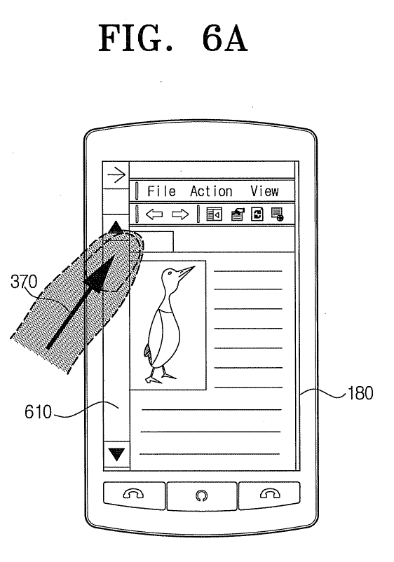

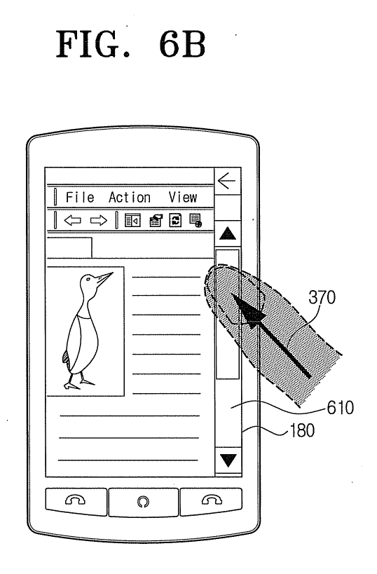

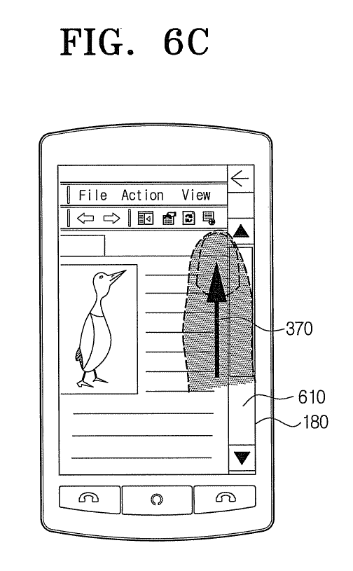

FIGS. 6A to 6C are views explaining a method of displaying dynamic UI elements according to an embodiment of the present invention. The UI elements of FIGS. 5A to 5C are static and do not move. When a dynamic UI element 610 (such as a scroll bar) is displayed on a viewable area of the touchscreen 180, a portion of the dynamic UI element 610 may be displayed on an un-viewable area to minimize a moving line of a finger. Referring to FIG. 6A, when a user holds an electronic apparatus in his or her left hand, the dynamic UI element 610 may be displayed vertically on a left edge of the touchscreen 180. As illustrated, the user can manipulate the dynamic UI element 610 with minimum movement of a finger, and a viewable area is maximized when the dynamic UI element 610 is manipulated. When a user holds an electronic apparatus in his or her right hand (as illustrated in FIG. 6B), the dynamic UI element 610 may be displayed vertically on a right edge of the touchscreen 180.

Since there is relatively less of a benefit to minimize a moving line of a finger when a user holds an electronic apparatus in one hand and inputs a command with the other hand, the dynamic UI element 610 may be displayed on a right or left edge of the touchscreen 180 in such a case. FIG. 6C is a view illustrating a state in which a dynamic UI element is displayed when a user manipulates an electronic apparatus with both hands.

When content (such as a UI element) is displayed, the content is displayed on a viewable area to minimize a moving line of a touching device (such as a finger or an input pen) to input a user command. Accordingly, a user convenience is improved.

While a 3D touch sensor transmits a degree of energy change to the control unit 190 using an electrostatic capacitance, it is understood that aspects of the present invention are not limited thereto. For example, other methods (such as laser, ultrasonic waves, infrared rays, and a fish eye lens) may be used to transmit a result regarding an object approaching the touchscreen 180 to the control unit 190.

Furthermore, while an MP3 player is provided as an electronic apparatus in the above descriptions, it is understood that the MP3 player is a non-limiting example of an electronic apparatus according to aspects of the present invention. Accordingly, aspects of the present invention may be applicable to a portable electronic apparatus (such as a mobile phone, a personal digital assistant (PDA), a video apparatus, a multimedia replay apparatus, and a television (TV)).

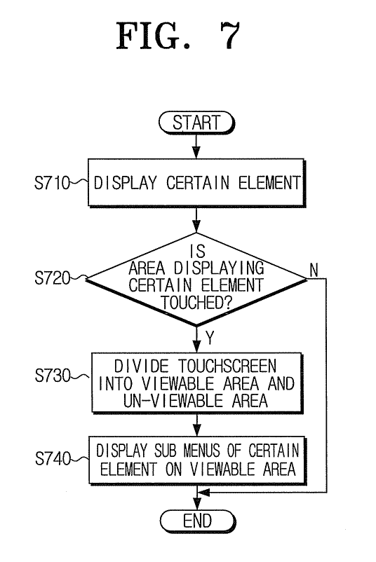

FIG. 7 is a flowchart explaining a method of displaying menus based on display areas according to another embodiment of the present invention. Referring to FIGS. 1 and 7, the touchscreen 180 displays an element in operation S710. The touchscreen 180 may display one single element or a plurality of elements.

The control unit 190 determines whether an area displaying the element is touched in operation S720. If it is determined that the area is touched (operation S720-Y), the control unit 190 divides the touchscreen 180 into a viewable area and an un-viewable area in operation S730, and controls the function blocks to display a sub menu corresponding to the element on the viewable area in operation S740. The sub menu may be represented as a plurality of elements.

As described above, according to aspects of the present invention, a content display area of an electronic apparatus is divided into a viewable area and an un-viewable area, whereby content is displayed on the viewable area such that a convenience of a user is improved when the user manipulates the electronic apparatus. Furthermore, as the content is dynamically displayed based on a viewable area and/or a type of the content, a user can more easily manipulate the electronic apparatus.

Aspects of the present invention can also be embodied as computer-readable codes on a computer-readable recording medium. Also, codes and code segments to accomplish the present invention can be easily construed by programmers skilled in the art to which the present invention pertains. The computer-readable recording medium is any data storage device that can store data which can be thereafter read by a computer system or computer code processing apparatus. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Aspects of the present invention may also be realized as a data signal embodied in a carrier wave and comprising a program readable by a computer and transmittable over the Internet.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of displaying content of an electronic apparatus using a touchscreen, the method comprising:
dividing the touchscreen into a viewable area and an un-viewable area according to a touching of the touchscreen; and
displaying the content on the viewable area.

2. The method as claimed in claim 1, further comprising:
displaying a selectable item on an area of the touchscreen,
wherein the dividing of the touchscreen comprises dividing the touchscreen into the viewable area and the un-viewable area when the area of the touchscreen on which the selectable item is displayed is touched.

3. The method as claimed in claim 2, wherein the displaying of the content comprises displaying a sub menu corresponding to the selected item on the viewable area.

4. The method as claimed in claim 3, wherein the displaying of the sub menu comprises arranging items of the sub menu in the viewable area adjacent to the selected item.

5. The method as claimed in claim 3, wherein the displaying of the sub menu comprises arranging items of the sub menu in a row in the viewable area such that a dragging path exists between an item of the sub menu and the selectable item.

6. The method as claimed in claim 3, wherein the displaying of the sub menu comprises displaying a dynamic item of the sub menu on an edge of the touchscreen.

7. The method as claimed in claim 6, wherein the displaying of the dynamic item comprises displaying the dynamic item on the edge of the touchscreen such that when touching the dynamic item, a viewable area is maximized.

8. The method as claimed in claim 1, wherein the touching is performed by a finger of a user.

9. The method as claimed in claim 1, wherein the dividing of the touchscreen comprises:
using a three dimensional (3D) touch sensor to recognize a spacing of the touching from the touchscreen by a predetermined distance.

10. The method as claimed in claim 9, wherein the dividing of the touchscreen comprises:
calculating a degree of energy change on the touchscreen;
determining the viewable area to be an area in which the degree of energy change is less than a predetermined value; and
determining the un-viewable area to be an area in which the degree of energy change is greater than or equal to the predetermined value.

11. The method as claimed in claim 10, wherein the determining of the un-viewable area comprises:
determining a first un-viewable area to be an area in which the degree of energy change is greater than or equal to the predetermined value and less than another predetermined value; and
determining a second un-viewable area to be an area in which the degree of energy change is greater than or equal to the other predetermined value,
wherein the first un-viewable area corresponds to an area that is covered but not primarily touched, and the second un-viewable area corresponds to an area that is primarily touched.

12. The method as claimed in claim 11, wherein the first un-viewable area includes a selectable item, such that the primary touching of the first un-viewable area causes the displaying of the content corresponding to the selectable item on the viewable area.

13. A computer readable recording medium encoded with the method of claim 1 and implemented by a computer.

14. An electronic apparatus to display content, the electronic apparatus comprising:
a touchscreen to receive a user command through a touching thereon, and to display the content corresponding to the user command; and
a control unit to divide the touchscreen into a viewable area and an un-viewable area according to the touching of the touchscreen, and to control the touchscreen to display the content corresponding to the user command on the viewable area.

15. The apparatus as claimed in claim 14, wherein:
the touchscreen displays a selectable item on an area thereof; and
the control unit divides the touchscreen into the viewable area and the un-viewable area if the touching is on the area displaying the selectable item.

16. The apparatus as claimed in claim 15, wherein the control unit controls the touchscreen to display a sub menu corresponding to the selected item on the viewable area.

17. The apparatus as claimed in claim 16, wherein the control unit controls the touchscreen to arrange items of the sub menu in the viewable area adjacent to the selected item.

18. The apparatus as claimed in claim 16, wherein the control unit controls the touchscreen to arrange items of the sub menu in a row in the viewable area such that a dragging path exists between an item of the sub menu and the selectable item.

19. The apparatus as claimed in claim 16, wherein the control unit controls the touchscreen to display a dynamic item of the sub menu on an edge of the touchscreen.

20. The apparatus as claimed in claim 19, wherein the control unit controls the touchscreen to display the dynamic item on the edge of the touchscreen such that when the touching is on the dynamic item, a viewable area is maximized.

21. The apparatus as claimed in claim 14, wherein the touching is performed by a finger of a user.

22. The apparatus as claimed in claim 14, further comprising:
a three dimensional (3D) touch sensor to recognize a spacing of the touching from the touchscreen by a predetermined distance, and to transmit a value of the spacing to the control unit.

23. The apparatus as claimed in claim 22, wherein the control unit calculates a degree of energy change on the touchscreen, determines the viewable area to be an area in which the degree of energy change is less than a predetermined value, and determines the un-viewable area to be an area in which the degree of energy change is greater than or equal to the predetermined value.

24. The apparatus as claimed in claim 23, wherein:
the control unit determines a first un-viewable area to be an area in which the degree of energy change is greater than or equal to the predetermined value and less than another predetermined value, and determines a second un-viewable area to be an area in which the degree of energy change is greater than or equal to the other predetermined value; and
the first un-viewable area corresponds to an area that is covered but not primarily touched, and the second un-viewable area corresponds to an area that is primarily touched.

25. The apparatus as claimed in claim 14, wherein the electronic apparatus is a portable electronic apparatus.

26. An electronic apparatus to display content, the electronic apparatus comprising:
a touchscreen to receive a user command through a touching thereon, and to display the content corresponding to the user command; and
a control unit to divide the touchscreen into a plurality of areas according to the touching of the touchscreen, and to control the touchscreen to display the content corresponding to the user command according to the dividing of the touchscreen.

27. The apparatus as claimed in claim 26, wherein:
the plurality of areas comprises a viewable area; and
the control unit controls the touchscreen to display the content corresponding to the user command on the viewable area.

28. The apparatus as claimed in claim 26, wherein:
the plurality of areas comprises an un-viewable area; and
the control unit controls the touchscreen to not display the content corresponding to the user command on the un-viewable area.

29. The apparatus as claimed in claim 26, wherein the control unit calculates a degree of energy change on the touchscreen, determines a first area, of the plurality of areas, to be an area in which the degree of energy change is less than a predetermined value, and determines a second area, of the plurality of areas, to be an area in which the degree of energy change is greater than or equal to the predetermined value.

30. A method of displaying content of an electronic apparatus using a touchscreen, the method comprising:
dividing the touchscreen into a plurality of areas according to a touching of the touchscreen; and
displaying the content according to the dividing of the touchscreen.

31. The method as claimed in claim 30, wherein the dividing of the touchscreen comprises:
calculating a degree of energy change on the touchscreen;
determining a first area, of the plurality of areas, to be an area in which the degree of energy change is less than a predetermined value; and
determining a second area, of the plurality of areas, to be an area in which the degree of energy change is greater than or equal to the predetermined value.
